(19) United States
(12) Patent Application Publication
(10) Pub. No.: US 2013/0191000 A1
(43) Pub. Date: Jul. 25, 2013

(54) STABILIZATION OF A VEHICLE COMBINATION

(71) Applicant: GM GLOBAL TECHNOLOGY OPERATIONS LLC, Detroit, MI (US)

(72) Inventor: Uwe HAHNE, Buettelborn (DE)

(73) Assignee: GM GLOBAL TECHNOLOGY OPERATIONS LLC, Detroit, MI (US)

(21) Appl. No.: 13/742,965

(22) Filed: Jan. 16, 2013

(30) Foreign Application Priority Data
Jan. 17, 2012 (DE) 102012000783.3

(51) Int. Cl. B60T 7/12

(52) U.S. Cl. CPC B60T 7/12
USPC 701/70

(57) ABSTRACT

A method and device for stabilizing a vehicle combination consisting of a tractor vehicle and a trailer are provided. The method includes determining a current traffic state in the environment of the tractor vehicle, determining a current driving state of the vehicle combination, and determining, based on the current traffic state and the current driving state, a value indicating a current probability for the vehicle combination having to carry out a braking maneuver and/or evasive maneuver that results in a critical driving state of the vehicle combination on a road section lying directly ahead. A braking intervention is automatically triggered, by which wheel brakes of the trailer are activated to stabilize the vehicle combination if the value is equal to or greater than a predetermined probability limit value.

### CROSS-REFERENCE TO RELATED APPLICATIONS

This application claims priority to German Patent Application No. 102012000783.3, filed Jan. 17, 2012, which is incorporated herein by reference in its entirety.

### TECHNICAL FIELD

The technical field pertains to a method and a device for stabilizing a vehicle combination consisting of a tractor vehicle and a trailer.

### BACKGROUND

Methods and devices for stabilizing a vehicle combination are known from the prior art. For example, DE 199 64 048 A1 discloses a method and a device for stabilizing a road vehicle, particularly a passenger car, with a trailer that is pulled by the road vehicle. The road vehicle is monitored with respect to rolling motions and, when a rolling motion is detected, a yawing moment that essentially is in phase opposition to the rolling motion is automatically impressed on the road vehicle.

DE 10 2004 010 296 A1 discloses a method for stabilizing a vehicle combination consisting of a tractor vehicle and a trailer or semitrailer. Symmetric braking interventions are initially carried out on the tractor vehicle when a rolling motion of the trailer or semitrailer is detected in order to dampen this rolling motion. Asymmetric braking interventions are subsequently carried out on the tractor vehicle if the desired attenuation of the rolling motion is not achieved by means of the symmetric braking interventions.

DE 10 2004 005 074 A1 discloses a device for damping the rolling motions of a trailer that is pulled by a road vehicle. The device comprises rolling motion detecting means for determining a rolling motion of the trailer, as well as the intensity of the rolling motion based on a variable, in which at least one variable that describes the lateral vehicle dynamics comes into play, and rolling motion damping means for damping the rolling motion based on automated braking interventions on the road vehicle and/or based on a driver-independent reduction of the engine torque if the intensity of the rolling motion exceeds an intensity limit value. The device furthermore comprises steering angle analyzing means for determining at least one parameter from the time history of the steering angle, wherein the aforementioned intensity limit value is dependent on the parameter.

The methods and devices for stabilizing a vehicle combination known from the prior art essentially concern the detection and damping of already existing rolling motions of the trailer and/or the tractor vehicle as they are induced, in particular, by braking and/or evasive maneuvers of the tractor vehicle.

It is at least one objective herein to provide a method and a device that allow an improved stabilization of a vehicle combination during braking and/or evasive maneuvers. In addition, other objects, desirable features and characteristics will become apparent from the subsequent summary and detailed description, and the appended claims, taken in conjunction with the accompanying drawings and this background.

### SUMMARY

A method for stabilizing a vehicle combination consisting of a tractor vehicle and a trailer is provided herein. In an embodiment, the inventive method is characterized in that a current traffic state in the environment of the tractor vehicle is determined. A current driving state of the vehicle combination is determined and a value indicating a current probability for the vehicle combination having to carry out a braking maneuver and/or evasive maneuver that results in a critical driving state of the vehicle combination on a road section lying directly ahead is continuously determined based on the current traffic state and the current driving state. Wheel brakes of the trailer are activated by an automated braking intervention in order to stabilize the vehicle combination if the determined value is equal to or greater than a predetermined probability limit value.

In the present context, the term “trailer” includes trailers that are connected to a trailer coupling of the tractor vehicle by means of a hitch (e.g., travel trailers, boat trailers, etc.) or so-called semitrailers that transfer part of their weight to the axles of the tractor vehicle to which they are connected by means of a fifth-wheel plate and a so-called “king pin.” The trailer presently features at least one axle that preferably has individually breakable wheels. With respect to trailers that feature several axles, the following explanations apply accordingly to each axle with breakable wheels.

In the present context, the term “traffic state” is interpreted in a broad sense. In an embodiment, it includes all traffic-relevant data for an environment of the tractor vehicle, particularly for an environment that lies ahead, referred to as the driving direction of the tractor vehicle. In this case, this environment preferably extends along a road section that lies directly ahead of the tractor vehicle up to a distance in the range of from about 100 m and to about 2 km, for example from about 200 m and to about 1 km or, such as, from about 200 m to about 500 m, from the tractor vehicle.

In an embodiment, the data on the current traffic state includes: current position data of objects (e.g., obstacles, driving vehicles or vehicles at a standstill, walls, guardrails, curb stones, plants, trees, buildings, lanterns, traffic lights, traffic signs, pedestrians, bicyclists, construction sites, lane markings, etc.) or data on the relative distances of the respective objects from the vehicle combination/tractor vehicle and data on the respective object speeds and their changes, dimensions and/or shapes.

In another embodiment, the data on the current traffic state also includes all current traffic information relevant to the tractor vehicle such as, for example, information on laws, prohibitions, hazards and the like as they are indicated by traffic lights, traffic signs, road markings and the like provided in the environment. For example, the data therefore includes traffic data such as: a traffic light is currently red, a traffic light currently switches from green to yellow, a stop sign is arranged at an intersection lying ahead, a traffic sign indicates a speed limit of 30 km/h, etc.

In a further embodiment, the data on the current traffic state also includes current navigation data relevant to the environment of the tractor vehicle such as, e.g., navigation data that can be generated based on a digital road map in connection with currently received traffic information. Such navigation data for example includes information on: the routing of the road lying ahead of the tractor vehicle, the number and size of traffic lanes, intersections and junctions lying ahead, the incline of the roadway lying ahead, the curvature radii of the roadway lying ahead, as well as information on: current construction sites lying ahead and current accident sites, an end of a traffic jam currently lying ahead, icy conditions and/or snow coverage and/or hydroplaning hazards on the roadway lying ahead, (large) potholes lying ahead and objects lying on the roadway lying ahead (lost bicycle, surfboard, lost refrigerator, etc.).

The current traffic state or the data describing the current traffic state in an embodiment is/are made available or determined by a navigation database provided in the tractor vehicle and/or by a sensor system provided in the tractor vehicle. The sensor system comprises one or more sensors, for example: camera systems and/or laser and/or radar and/or ultrasonic sensors, by means of which the environment of the tractor vehicle is scanned such that the environment of the tractor vehicle also can be respectively determined in an up-to-date fashion with respect to its dynamic behavior. Such sensors for determining a static and/or dynamic environment and corresponding evaluation algorithms for the measuring data determined by means of these sensors are known from the pertinent prior art.

Data on the current traffic state, for example, is also received in a non-wired or wireless fashion, for example, from a provider of current traffic data via mobile Internet (GMS, UMTS) or via a radio traffic channel (TMC=“Traffic Message Channel”). Data on the current traffic state also can be transmitted by other vehicles in the environment via “car-to-car” communication or by traffic infrastructure devices via “car-to-x” communication and taken into consideration in the determination of the current traffic state. For example, a current switching state of a traffic light lying ahead can be directly transmitted to the vehicle combination by the traffic light or a current end of a traffic jam can be transmitted to the vehicle combination by a vehicle driving ahead.

In an embodiment, the current traffic state is continuously determined based on a combination of the data provided or transmitted by the above-described data sources and for example is available with an update rate in the range of from about 10 Hz to about 100 Hz, for example, from about 50 Hz to about 100 Hz. The current traffic state may be defined in the form of a “state vector.”

The data originating from the various data sources preferably is also matched with one another such that it is possible, in particular, to identify contradicting data. It is also preferred to utilize redundant data such that it is possible, e.g., to determine objects on a road section lying ahead of the tractor vehicle by evaluating measuring data of a camera system on the one hand and by evaluating measuring data of a radar system on the other hand. Both of these evaluations serve for improving the reliability in determining the current traffic state.

In the present context, the term “current driving state” of the vehicle combination is likewise interpreted in a broad sense. The current driving state of the vehicle combination is defined by one or more parameters. These parameters include one or more of the following (measured) variables: current position of the tractor vehicle, speed of the tractor vehicle and/or the trailer, longitudinal acceleration of the tractor vehicle and/or the trailer, lateral acceleration of the tractor vehicle and/or the trailer, steering angle of the tractor vehicle, articulation angle between tractor vehicle and trailer, angular articulation velocity, axle load distribution of the tractor vehicle and/or the trailer, rotational speeds of individual wheels of the tractor vehicle and/or the trailer, wheel slip of individual wheels of the tractor vehicle and/or the trailer, yaw rate of the tractor vehicle and/or the trailer, current driving mode of the tractor vehicle (a. manual driving mode (manual steering interventions, manual braking and accelerating); b. semiautomatic driving mode (e.g., utilization of a longitudinal control system, lateral control by means of manual steering interventions), or c. fully automated driving mode (fully automated longitudinal and lateral control)), as well as the driving route of the tractor vehicle currently selected in a navigation system.

The “current driving state” of the vehicle combination is continuously determined and made available by means of corresponding sensors known from the prior art that are respectively arranged in the tractor vehicle and in the trailer. In an embodiment, an update rate of the current driving state of the vehicle combination lies in the range of from about 10 Hz to about 100 Hz, for example, from about 50 Hz to about 100 Hz. For further processing, the current driving state preferably is also defined in the form of a “state vector” that respectively comprises individual above-described parameters or combinations thereof.

According to an exemplary embodiment, a value indicating a current probability for the vehicle combination having to carry out a braking maneuver and/or evasive maneuver that results in a critical driving state of the vehicle combination on a road section lying directly ahead is (continuously) determined based on the determined current traffic state and the determined current driving state. For this purpose, data preferably is likewise made available in the form of “state vectors” that characterize critical driving states. Such “critical state vectors” are respectively formed by individual above-described driving state variables or combinations thereof.

In an embodiment, an evaluation means is provided in the vehicle combination, for example, in the tractor vehicle, wherein this evaluation means analyzes in an anticipatory fashion and evaluates whether a braking maneuver and/or an evasive maneuver of the tractor vehicle that results in a critical driving state of the vehicle combination is imminent based on the determined current traffic state in the environment of the tractor vehicle, particularly the environment lying ahead in the driving direction of the tractor vehicle, the determined current driving state of the vehicle combination, and the provided data on critical driving states.

In another embodiment, in the determination of the value for the current probability, the evaluation means utilizes a database provided for this purpose or one or more look-up table(s), in which values for probabilities of a braking maneuver and/or evasive maneuver are stored for different combinations of given traffic states and driving states.

The evaluation means alternatively or additionally calculates the value for the current probability of an imminent braking maneuver and/or evasive maneuver resulting in a critical driving state of the vehicle combination based on the current traffic state and the current driving state of the vehicle combination by means of a predetermined mathematical-physical model of the vehicle combination and an environment model that is based on the current traffic state, namely in a corresponding simulation program that is installed on the evaluation means, e.g., in the form of software and executed thereon.

The value of the current probability is determined by the evaluation means in a continuously updated fashion such that the value is available with an update rate that essentially depends on the update rate of the current traffic state and the current driving state. If this value of the current probability is equal to or greater than a predetermined probability limit value, an automatic braking intervention that activates the wheel brakes of the trailer is carried out in order to stabilize the vehicle combination. In this case, the automatic braking intervention typically takes place prior to the initiation of a braking maneuver and/or evasive maneuver and therefore causes an anticipatory longitudinal stabilization of the vehicle combination that also prevents or reduces the risk of the trailer colliding with the tractor vehicle during an (emergency) braking maneuver and dampens the occurrence of rolling motions during an (emergency) evasive maneuver.

In an embodiment, the intensity of the braking intervention is dependent on the current driving state or alternatively always realized with maximum attainable delay.

The probability limit value is preferably chosen such that an accident still can be realistically prevented with a braking maneuver and/or evasive maneuver to be initiated on short notice.

Prior to an imminent braking maneuver and/or evasive maneuver, the vehicle combination typically drives without the occurrence of rolling motions such that the tractor vehicle and the trailer form a dynamically stable system. However, if an imminent braking maneuver and/or evasive maneuver that would result in a critical state of the vehicle combination is detected, i.e., if the value of the current probability exceeds the probability limit value, the inventive automatic activation of the wheel brakes of the trailer largely stabilizes the vehicle combination prior to and during the actual braking or steering maneuver and therefore contributes to a noticeable reduction of the accident probability during braking maneuvers and/or evasive maneuvers of vehicle combinations. In contrast to the prior art, a braking intervention is presently already carried out prior to the occurrence of a rolling motion of the trailer or the tractor vehicle due to an anticipatory evaluation of the chronological development of a current driving scenario (that is defined by the current traffic state and the current driving situation). In further contrast to the prior art, the braking intervention is presently not carried out on the tractor vehicle, but rather on the trailer.

The activation of the wheel brakes of the trailer preferably takes place symmetrical at least at the beginning of the braking intervention. In the present context, a symmetrical braking intervention refers to both wheels of an axle of the trailer being identically decelerated, for example, to the brake linings being pressed against the brake discs with the same intensity. The wheel brakes of the trailer preferably feature an antilock braking system (ABS system) such that a maximal braking moment transfer can be realized on the one hand and blocking of the wheels is prevented on the other hand. The wheels of the trailer preferably are also individually controllable/breakable.

In a further embodiment, the braking intervention takes place symmetrical or asymmetrical depending on the current driving state.

In another embodiment, after a steering intervention in the tractor vehicle that initiates driving through a curve, one or more wheels of the trailer on the inner side of the curve are automatically decelerated more intensely than wheels on the outer side of the curve. In this variation, the automatic symmetrical braking intervention that is initiated in the above-described fashion by exceeding the predetermined probability limit value and carried out prior to initiating a braking maneuver and/or evasive maneuver is converted into an asymmetrical braking intervention when the tractor vehicle respectively initiates driving through a curve or drives through a curve. This asymmetrical braking intervention, i.e., differently intense deceleration of the wheels of an axle, subjects the trailer to a yawing moment that supports the vehicle combination in driving through a curve and dampens the occurrence of rolling motions.

Depending on the driving state, the reverse instance naturally would also be conceivable, i.e., one or more wheels of the trailer on the outer side of the curve are automatically decelerated more intensely than wheels on the inner side of the curve while driving through the curve, e.g., in order to dampen already occurring rolling motions of the trailer.

It would be conceivable that situations arise, in which the determination of a reliable current traffic state in the environment of the tractor vehicle and/or the determination of a reliable current driving state is not possible, e.g., due to the failure of sensors required for this purpose or due to the required information not being available with sufficient quality and reliability such that the inventive method cannot be carried out.

In such a situation, in an embodiment, the driver of the tractor vehicle is informed accordingly by outputting an optical and/or acoustical winning and the inventive method preferably is stopped. If the automated braking intervention has already taken place in such a situation, it is preferred to utilize the following options for terminating the method in an automated fashion. On the one hand, the current braking intervention, i.e., the wheel brakes of the trailer, can be immediately deactivated. On the other hand, the current braking intervention may be continued in an unchanged fashion until predetermined conditions are reached and subsequently deactivated (e.g., once a predetermined time period expires) or the intensity of the current braking intervention may be reduced to “zero,” i.e., no brake force, in accordance with a predetermined function.

However, in order to still achieve the most optimal stabilization of the vehicle combination possible during a braking maneuver and/or evasive maneuver in situations in which the determination of a reliable current traffic state in the environment of the tractor vehicle and/or the determination of a reliable current driving situation is not possible, in an embodiment, the wheel brakes of the trailer also are redundantly activated due to the automated braking intervention if a lateral acceleration of the tractor vehicle greater than or equal to a predetermined lateral acceleration limit value is determined and/or a deceleration of the tractor vehicle greater than or equal to a predetermined deceleration limit value is determined and/or a yaw rate of the tractor vehicle is determined.

In the present context, the word “redundant” refers to this variation of the method only being carried out if the above-described inventive automatic braking intervention that is based on an anticipatory evaluation of the probability of a braking maneuver and/or evasive maneuver did not take place or could not take place.

An optical and/or acoustical warning is preferably output for the driver of the tractor vehicle if a braking intervention is automatically triggered or when the determined value of the current probability exceeds the predetermined probability limit value. In this way, the driver is informed of the fact that the wheel brakes of the trailer are activated due to an automated braking intervention. In this respect, the driver is able to attribute the noticeable automated braking intervention. The warning being output also purposefully focuses the attention of the driver on the imminent braking maneuver and/or evasive maneuver.

A braking intervention that was already triggered in an automated fashion preferably is terminated with a manual input of the driver on an input means, e.g., by manually actuating a lever or a button on the steering wheel and, in particular, by completely depressing the accelerator/gas pedal of the tractor vehicle.

It is also preferred that all system components required for carrying out the inventive method and its preferred enhancements are continuously analyzed with respect to defects and system availability. If errors occur during such a system check, a warning is output in order to inform the driver of the fact that the inventive method can currently not be carried out and the method is prevented from being carried out for safety reasons. If a braking intervention was already triggered during such a failing system check, it is preferred to utilize the following options for terminating the method in an automated fashion. On the one hand, the current braking intervention, i.e., the wheel brakes of the trailer, can be immediately deactivated automatically. On the other hand, the current braking intervention may be continued in an unchanged fashion until predetermined conditions are reached and subsequently deactivated (e.g., once a predetermined time period expires) or the intensity of the current braking intervention may be reduced to “zero,” i.e., no brake force, in accordance with a predetermined function.

In an exemplary embodiment (functional system/system check without errors), an automatically initiated braking intervention preferably is terminated in an automated fashion when the value of the current probability is once again lower than the predetermined probability limit value and the current driving state is not a critical driving state. Once the determined value of the current probability is once again lower than the predetermined probability limit value and the current driving state is not a critical driving state, the braking intervention is alternatively terminated after predetermined conditions exist or as far as the intensity of the braking intervention is concerned.

Tractor vehicles and even some trailers are nowadays equipped with safety systems, assistance systems and/or comfort systems for their longitudinal and lateral control. In order to avoid conflicts with control interventions of other safety systems, assistance systems and/or comfort systems of the vehicle combination, the inventive braking intervention presently is preferably coordinated with the safety systems, assistance systems and/or comfort systems of the tractor vehicle and, if applicable, the trailer.

In another embodiment, a device for stabilizing a vehicle combination consisting of a tractor vehicle and a trailer is provided. The device includes an environment acquisition system, by which a current traffic state in the environment of the tractor vehicle can be determined, a sensor system, by which a current driving state of the vehicle combination can be determined, an evaluation means, by which a value indicating a current probability for the vehicle combination having to carry out a braking maneuver and/or evasive maneuver that results in a critical driving state of the vehicle combination on a road section lying directly ahead can be determined based on the current traffic state and the current driving state, and a control means, by which wheel brakes of the trailer can be activated due to an automated braking intervention in order to stabilize the vehicle combination if the determined value is equal to or greater than a predetermined probability limit value.

In another embodiment, a first means is provided for determining a current longitudinal deceleration of the tractor vehicle and/or a second means is provided for determining a current lateral acceleration of the tractor vehicle and/or a third means is provided for determining a current yaw rate of the tractor vehicle. In this embodiment, the control means is realized and configured in such a way that the wheel brakes of the trailer are redundantly activated due to an automated braking intervention in order to stabilize the vehicle combination if the current lateral acceleration is greater than or equal to a predetermined lateral acceleration limit value and/or the current deceleration is greater than or equal to a predetermined deceleration limit value and/or the current yaw rate is greater than or equal to a yaw rate limit value. It is also preferred that the wheel brakes of the trailer can be individually activated on each wheel.

Advantageous enhancements, corresponding advantages and elucidations of the device result from analogously transferring and applying the preceding explanations with respect to the inventive method to the above-described device.

In a further embodiment, a vehicle with an inventive device of the above-described type is provided.

### BRIEF DESCRIPTION OF THE DRAWINGS

The various embodiments will hereinafter be described in conjunction with the following drawing figures, wherein like numerals denote like elements, and wherein:

FIG. 1 shows a flow chart of a method for stabilizing a vehicle combination in accordance with an exemplary embodiment; and

FIG. 2 shows a schematic representation of a vehicle combination with a device for stabilizing the vehicle combination, in accordance with an exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

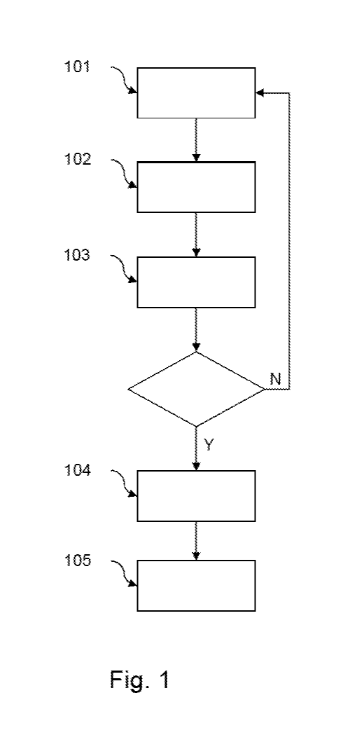

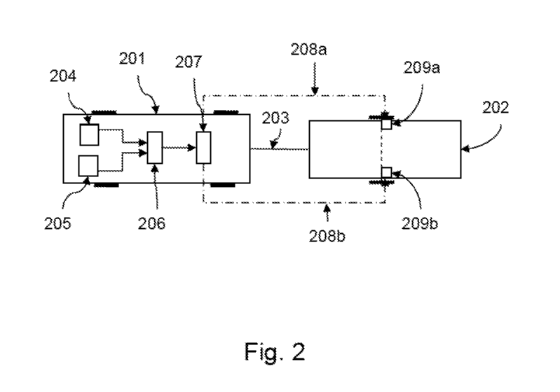

FIG. 1 shows a flow chart of an inventive method for stabilizing a vehicle combination during a braking maneuver and/or an invasive maneuver in accordance with an exemplary embodiment. The vehicle combination comprises a tractor vehicle 201 and a trailer 202 connected thereto, as illustrated in FIG. 2. The method includes the following steps. In a first step 101, a current traffic state in the environment of the tractor vehicle 201 is determined For this purpose, the tractor vehicle 201 features laser, radar and ultrasonic sensors for scanning the environment of the tractor vehicle 201, particularly the environment lying ahead in the driving direction. The tractor vehicle 201 presently also features a camera system for acquiring, in particular, the environment of the tractor vehicle 201 lying ahead in the optical and infrared spectral range. The measuring data generated by these sensors provided on the tractor vehicle is evaluated and delivered for describing the current traffic state. In addition, environment data that is transmitted to the tractor vehicle 201 by a service provider via mobile Internet and by other vehicles via car-to-car communication and by a traffic infrastructure via car-to-x communication is presently also taken into consideration. The tractor vehicle features the receiving means required for this purpose. The data generated/transmitted by the above-described data sources in its entirety defines the current traffic state in the environment of the tractor vehicle 201 at a current time t. The current traffic state is updated with an update rate of, for example, 10 Hz.

In a second step 102, a current driving state of the vehicle combination consisting of the tractor vehicle 201 and the trailer 202 is determined In this respect, sensors provided in the tractor vehicle 201 anyhow are used for determining the current position, the current speed, the change in speed, the current driving direction, the current steering angle and the current position of the gas pedal and of the brake pedal in the tractor vehicle 201. Other parameters, particularly also parameters that define the driving state of the trailer 202, may also be incorporated depending on the respective requirements and the availability of corresponding sensors in the trailer. The current driving state is updated with an update rate of, for example, 10 Hz.

In a third step 103, a value indicating a current probability for the vehicle combination having to carry out a braking maneuver and/or evasive maneuver that results in a critical driving state of the vehicle combination on a road section lying ahead is determined based on the previously determined current traffic state and the previously determined current driving state.

In this exemplary embodiment, the value of the current probability is determined by means of a mathematical-physical model of the vehicle combination that utilizes data on the current traffic state and on the current driving state of the vehicle combination as input data and is installed as software on the evaluation means 206 in the form of a corresponding program code executed thereon.

If the value of the current probability in a current scenario is equal to or greater than a predetermined probability limit value (identified as “Y” in FIG. 1), wheel brakes of the trailer are activated in a fourth step 104 due to an automatic symmetrical braking intervention in order to stabilize the vehicle combination. However, no braking intervention takes place if the value of the current probability is smaller than the predetermined probability limit value.

In a step 105, the automatically initiated braking intervention is presently terminated in an automated fashion once the value of the current probability is once again smaller than the predetermined probability limit value and the current driving state is not a critical driving state. For this purpose, the current driving state is compared with predetermined critical driving states.

FIG. 2 shows a schematic representation of a vehicle combination with an inventive device for stabilizing the vehicle combination during braking maneuvers and/or evasive maneuvers. The vehicle combination comprises a tractor vehicle 201 and a trailer 202 connected thereto by means of a trailer hitch 203. The device comprises an environment acquisition system 204, by which a current traffic state in the environment of the tractor vehicle 201 can be determined. In addition to vehicle sensors, the environment acquisition system 204 comprises other radio interfaces for receiving relevant data and information on the current traffic state in the environment of the tractor vehicle 201 from other vehicles (car-to-car), from a traffic infrastructure (car-to-x) and from a traffic channel (TMC).

The device furthermore comprises a sensor system 205, by which a current driving state of the vehicle combination, i.e., of the tractor vehicle 201 and the trailer 202, can be determined. The current driving state presently includes the following parameters, for example: the speed of the tractor vehicle 201, the longitudinal acceleration of the tractor vehicle 201, the lateral acceleration of the tractor vehicle 201, the articulation angle between the tractor vehicle 201 and the trailer 202, the angular articulation velocity, as well as a yaw rate of the tractor vehicle 201 and of the trailer 202.

The device also comprises an evaluation means 206, by which a value indicating a current probability for the vehicle combination having to carry out a braking maneuver and/or evasive maneuver that results in a critical driving state of the vehicle combination on a road section lying ahead is determined based on the respectively determined current traffic state and the respectively determined current driving state. In the present embodiment, data on critical driving states is made available to the evaluation means 206 by a storage unit for this purpose.

The device ultimately comprises a control means 207, by which wheel brakes 209a, 209b of the trailer 202 are activated due to an automated braking intervention in order to stabilize the vehicle combination if the value of the current probability is equal to or greater than a predetermined probability limit value.

The broken lines 208a and 208b in FIG. 2 schematically indicate the respective control connections between the control means 207 and the respective wheel brakes 209a, 209b of the single-axle trailer 202, however, without reflecting their concrete realization. Various corresponding realizations are easily accessible to a person skilled in the art.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for stabilizing a vehicle combination consisting of a tractor vehicle and a trailer, the method comprising the steps of:
determining a current traffic state in an environment of the tractor vehicle;
determining a current driving state of the vehicle combination;
determining, based on the current traffic state and the current driving state, a value indicating a current probability for the vehicle combination having to carry out a braking maneuver and/or evasive maneuver that results in a critical driving state of the vehicle combination on a road section lying directly ahead; and
automatically triggering a braking intervention, by which wheel brakes of the trailer are activated to stabilize the vehicle combination, if the value is equal to or greater than a predetermined probability limit value.

2. The method according to claim 1, further comprising outputting an optical and/or acoustical warning for a driver when the braking intervention is automatically triggered.

3. The method according to claim 1, further comprising, depending on the current driving state:
controlling an intensity of the braking intervention; and/or
carrying out the braking intervention symmetrically or asymmetrically.

4. The method according to claim 1, further comprising, after a steering intervention that initiates driving through a curve, decelerating one or more wheels of the trailer on an inner side of the curve more intensely than wheels of the trailer on an outer side of the curve due to the braking intervention on the tractor vehicle.

5. The method according to claim 1, further comprising coordinating the braking intervention with other safety, assistance and/or comfort systems of the tractor vehicle and/or the trailer.

6. The method according to claim 1, further comprising terminating an automatically triggered braking intervention with a manual input of a driver on an input means of the tractor vehicle.

7. The method according to claim 1, further comprising terminating an automatically triggered braking intervention in an automated fashion if the value indicating the current probability is once again smaller than the predetermined probability limit value and the current driving state is not the critical driving state.

8. The method according to claim 1, wherein determining the current driving state of the vehicle combination comprises determining one or more of the following:
speed of the tractor vehicle and/or the trailer;
longitudinal acceleration of the tractor vehicle and/or the trailer;
lateral acceleration of the tractor vehicle and/or the trailer;
steering angle of the tractor vehicle;
articulation angle between the tractor vehicle and the trailer;
angular articulation velocity;
axle load distribution of the tractor vehicle and/or the trailer;
rotational speeds of individual wheels of the tractor vehicle and/or the trailer;
wheels slip of individual wheels of the tractor vehicle and/or the trailer; and/or
yaw rate of the tractor vehicle and/or the trailer.

9. The method according to claim 1, wherein determining the current traffic state includes determining positions, speeds and accelerations of vehicles or obstacles present in an environment lying ahead of the tractor vehicle.

10. The method according to claim 1, further comprising triggering a redundant braking intervention, by which the wheel brakes of the trailer are activated, in instances in which the current traffic state or the current driving state cannot be determined or not determined with sufficient reliability if:
a lateral acceleration of the tractor vehicle greater than or equal to a predetermined lateral acceleration limit value is determined; and/or
a yaw rate of the tractor vehicle greater than or equal to a predetermined yaw rate limit value is determined; and/or
a longitudinal deceleration of the tractor vehicle greater than or equal to a predetermined deceleration limit value is determined.

11. A device for stabilizing a vehicle combination consisting of a tractor vehicle and a trailer, comprising:
an environment acquisition system configured to determine a current traffic state in an environment of the tractor vehicle;
a sensor system configured to determine a current driving state of the vehicle combination;
an evaluation means configured to determine, based on the current traffic state and the current driving state, a value indicating a current probability for the vehicle combination having to carry out a braking maneuver and/or an evasive maneuver that results in a critical driving state of the vehicle combination on a road section lying ahead; and
a control means configured to activate wheel brakes of the trailer due to an automated braking intervention to stabilize the vehicle combination if the value is equal to or greater than a predetermined probability limit value.

12. The device according to claim 11, wherein the wheel brakes of the trailer can be individually activated on each wheel.

13. A vehicle with a device for stabilizing a vehicle combination consisting of a tractor vehicle and a trailer, comprising:
an environment acquisition system configured to determine a current traffic state in an environment of the tractor vehicle;
a sensor system configured to determine a current driving state of the vehicle combination;
an evaluation means configured to determine, based on the current traffic state and the current driving state, a value indicating a current probability for the vehicle combination having to carry out a braking maneuver and/or an evasive maneuver that results in a critical driving state of the vehicle combination on a road section lying ahead; and
a control means configured to activate wheel brakes of the trailer due to an automated braking intervention to stabilize the vehicle combination if the value is equal to or greater than a predetermined probability limit value.

14. The vehicle according to claim 13, wherein the wheel brakes of the trailer can be individually activated on each wheel.
